(19) United States
(12) Patent Application Publication
(10) Pub. No.: US 2007/0038790 A1
(43) Pub. Date: Feb. 15, 2007

(54) Integrated circuit devices, methods, and computer program products for monitoring a bus

(76) Inventor: Young-Min Lee, Gyeonggi-do (KR)

Correspondence Address: MYERS BIGEL SIBLEY & SAJOVEC, PO BOX 37428, RALEIGH, NC, 27627, US

(21) Appl. No.: 11/498,611

(22) Filed: Aug. 3, 2006

(30) Foreign Application Priority Data
Aug. 11, 2005 (KR) 10-2005-0073883

(51) Int. Cl. G06F 13/36

(52) U.S. Cl. 710/113

(57) ABSTRACT

An integrated circuit device is comprised of a bus, at least two master units connected with the bus, and a monitoring circuit configured to monitor transactions between the master units through the bus and store transaction information into a programmable device-embedded memory during SOC design.

### CROSS-REFERENCE TO RELATED APPLICATIONS

This U.S. non-provisional patent application claims priority under 35 U.S.C. § 119 of Korean Patent Application 2005-73883 filed on Aug. 11, 2005, the entire content of which is hereby incorporated by reference.

### FIELD OF INVENTION

The subject matter disclosed herein is concerned with integrated circuit devices. In particular, the subject matter disclosed herein relates to an integrated circuit device for monitoring a state of a bus occupied by one or more master units.

### BACKGROUND

The subject matter disclosed herein is concerned with integrated circuit devices. In particular, the subject matter disclosed herein relates to an integrated circuit device for monitoring a state of a bus occupied by one or more master units.

With the miniaturization and complication of semiconductor integrated circuit devices, system-on-chips (hereinafter, referred to as ‘SOC’) have become influential in efficiently implementing electronic circuit structures for various functional applications. Usually, an SOC is fabricated to include all hardware and software functions for an integrated circuit system, such as a processor, a memory, an external interface, an analog and mixed-mode block, embedded software, and an operating system (OS). The SOC is generally configured in a size larger than other chips because many functional blocks may be integrated in a single chip for an integrated circuit system, consuming a longer development time. As it is well known, the commercial business is heavily dependent on how early semiconductor chips are put into the market, which means the integrated circuit design may be needed as soon as possible.

When designing an SOC, hardware and software features may be designed at the same time, which is usually not the case with other semiconductor chips. A general sequence for designing an SOC typically proceeds by laying out the behavioral level, the register transfer level (RTL), the field programmable gate array (FPGA), and the SOC mask, in this order.

In the meantime, the functional circuit blocks arranged in the SOC, such as the processor, the memory, the external interface, and the analog and mixed-mode block, communicate by way of a bus. An arbiter can control the conditions of bus occupation by the functional blocks, preventing or reducing conflicts in bus occupation.

Some items to be considered in designing an SOC circuit configuration include bus occupation periods and the rates used by the functional blocks. A bus monitoring mode generally adopts the period or rate used in the step of laying out the RTL, but it takes time to execute all of the real applications at the RTL layout step.

### SUMMARY

Accordingly, the invention is directed to an integrated circuit device capable of monitoring bus activity in an SOC system.

In some embodiments according to the present invention, an integrated circuit device includes a bus, at least two master units connected with the bus, and a monitoring circuit configured to inspect the transactions between the master units through the bus and store the transaction information into a programmable device-embedded memory, such as an FPGA-embedded memory. Monitoring may include, but is not limited to, inspecting, analyzing, storing, retrieving, manipulating, or communicating signals and transaction information. Inspecting may include measuring and collecting transaction information. Transaction information may include the period of time from which a master unit is granted access to the bus until when the master unit releases the bus. This information will sometimes be referred to as transaction time information. Transaction time information may also include the time used for a particular process or type of process. Time may also be defined by clock cycles or any other unit of action or time. Transaction information may also include information about modes of operation such as granting, writing or other modes such as those discussed below.

In some embodiments according to the present invention, the monitoring circuit includes a controller configured to write and read the transaction information to and from the FPGA-embedded memory. The monitoring circuit also includes an interface configured to output the transaction information from the FPGA-embedded memory to the outside. The interface may be a joint test access group (JTAG) interface. The integrated circuit device may also include an arbiter configured to arbitrate the master units in occupying the bus. Arbitration includes, but is not limited to, scheduling the transactions of the master units in a manner that reduces or eliminates inefficient or conflicting occupation of the bus.

In some embodiments according to the present invention, the monitoring circuit includes an analyzer configured to receive a signal communicated between the master units through the bus and generate an address signal, at least one control signal, and the transaction information in accordance with the communicated signal. The monitoring circuit also comprises a storage circuit configured to store the transaction information into the FPGA-embedded memory and/or read the transaction information from the FPGA-embedded memory in response to the address and control signals. The transaction information may include information about a time or number of cycles (clock, program or system) consumed or required for the transaction. The analyzer of the monitoring circuit is configured to generate an address signal that corresponds with the transaction. The storage circuit of the monitoring circuit is configured to read out information such as information regarding the accumulated transaction processing time from the FPGA-embedded memory in response to the address and control signals.

In some embodiments according to the present invention, the analyzer of the monitoring circuit includes an adder configured to add a transaction processing time to the accumulated transaction processing time. The storage circuit is configured to read accumulated transaction information from an FPGA-embedded memory and transmit the information to the adder in response to the address and control signals. The storage circuit stores information about the accumulated transaction processing time into the FPGA-embedded memory from the adder.

In some embodiments according to the present invention, the monitoring circuit includes an analyzer configured to receive a signal communicated between the master units through the bus and generate the transaction information and at least one control signal in accordance with the communicated signal. The monitoring circuit also includes a storage circuit configured to store the transaction information into an FPGA-embedded memory and/or read the transaction information from the FPGA-embedded memory in response to the control signal. The storage circuit is configured to generate addresses in sequence and store the transaction information at the addresses of the FPGA-embedded memory. The storage circuit may also read the transaction information from the addresses of the FPGA-embedded memory. The transaction information may include information about an operation mode and a transaction processing time or number of cycles used in accordance with the signal communicated between the master units through the bus.

In some embodiments according to the present invention, a method for monitoring a bus includes: receiving signals by way of a bus; generating transaction information in correspondence with the signals; and storing the transaction information into an FPGA-embedded memory. In this embodiment, the transaction information may include a time for processing the transaction. This embodiment may also include regulating the transaction in occupying the bus.

In some embodiments according to the present invention, a method for monitoring a bus includes: generating an address in response to signals transferred through a bus; obtaining information about the time or cycles (clock, program or system cycles) required or consumed for the transaction in response to the signals transferred through the bus; reading accumulated time or cycle information from an address of an FPGA-embedded memory; adding the transaction time or cycle information to the accumulated time or cycle information; and storing the newly accumulated time or cycle information into the address or addresses of the FPGA-embedded memory.

In some embodiments according to the present invention, a method for monitoring a bus includes: generating transaction mode information in response to signals transferred through a bus; obtaining information about the time or cycles required or consumed for a transaction in response to the signals transferred through the bus; generating an address of an FPGA-embedded memory; and storing the time or cycle information and the transaction mode information into the address of the FPGA-embedded memory.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified. In the figures:

FIG. 1 is a block diagram illustrating an internal organization of an integrated circuit device in accordance with some embodiments of the invention.

FIG. 2 is a block diagram illustrating a structure of a monitoring circuit in some embodiments according to the invention.

FIG. 3 is a timing diagram showing signals operating in the monitoring circuit shown in FIG. 2.

FIG. 4 is a block diagram illustrating a monitoring circuit in accordance with some embodiments of the invention.

FIG. 5 is a timing diagram showing signals operating in the monitoring circuit shown in FIG. 4.

### DETAILED DESCRIPTION OF EMBODIMENTS ACCORDING TO THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a” , “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense expressly so defined herein.

The present invention is described below with reference to diagrams (such as block diagrams) and/or operational illustrations of methods, circuits, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

Computer program code or “code” for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

The computer program code may be provided to a processor of a general purpose computer, special purpose computer, or other programmable data processing apparatus as instructions to produce a machine, such that the instructions, which execute via the processor of the computer or other programmable data processing apparatus, create means for implementing the functions specified in the block and/or flowchart block or blocks.

The computer code may be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

A field programmable gate array (FPGA) is a type of semiconductor logic circuit system that offers flexibility to a designer in laying out the circuit configuration. The FPGA is useful for verifying functional blocks of an SOC system before manufacturing the SOC system. The FPGA may shorten commercialization time and provide the flexibility to modify the circuit logic while it is in use or development. Although an FPGA is used in some embodiments of the invention, other programmable embedded-memory devices may be used.

Many embodiments of the present invention comprise an integrated circuit device configured to store bus monitoring information in an FPGA-embedded memory at the FPGA design step of SOC organization.

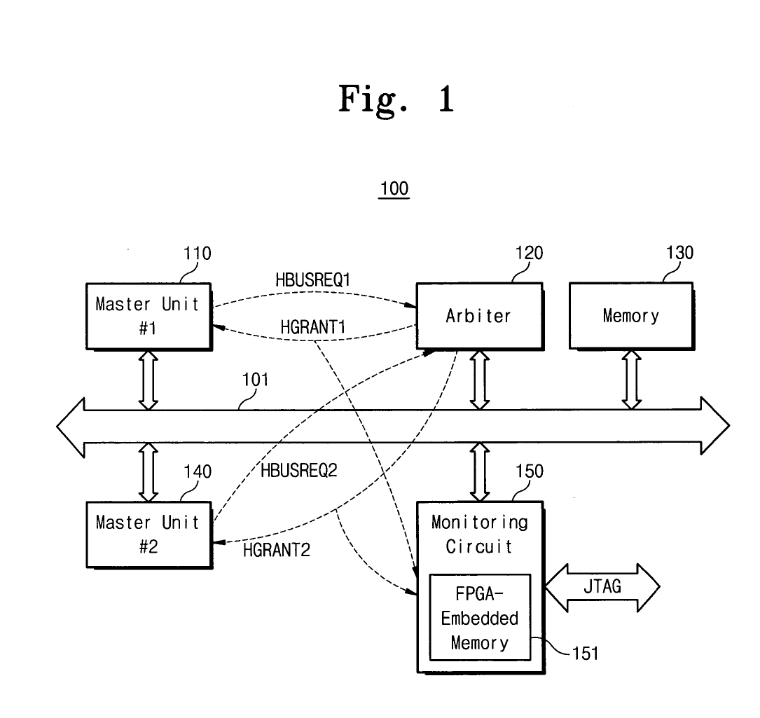

FIG. 1 is a block diagram illustrating an internal organization of an integrated circuit device in accordance with some embodiments of the invention. Referring to FIG. 1, the integrated circuit device 100 is comprised of a system bus 101, any number of master units 110 and 140 connected with the system bus 101, and a memory 130. The system bus 101 is configured as an AMBA (advanced microcontroller bus architecture) AHB (advanced high-performance bus). The master units 110 and 140 are functional circuit blocks connected to the AHB, such as a microprocessor, a digital signal processor, a memory, or an external interface. For instance, the master units 110 and 140 read/write data from/to the memory 130 through the bus 101.

An arbiter 120 is coupled to the bus 101, transferring grant signals HGRANT1 and HGRANT2 to the master units 110 and 140 corresponding thereto in response to bus request signals HBUSREQ1 and HBUSREQ2 that are provided from the master units.

A monitoring circuit 150 according to the some embodiments of the present invention is connected to the bus 101 and includes an FPGA-embedded memory 151. The monitoring circuit 150 inspects or measures a time for a transaction to transfer data and control signals between the master units 110 and 140 or between the master units 110 and 140 and the memory 130, and stores the measured results in the FPGA-embedded memory 151. The time used for a transaction is the period of time the transaction occupies the bus 101. The transaction time can be used to find the bus occupation rates of the master units 110 and 140 in the integrated circuit device 100. The transaction time may also be referred to as transaction information.

The FPGA-embedded memory 151 of the monitoring circuit 150 is a memory employed for the monitoring circuit 150 or a memory used at the FPGA design step. When the memory for the FPGA design is used for storing the bus monitoring information, idle spaces of the memory are partially employed therefor. The monitoring information stored in the FPGA-embedded memory 151 of the monitoring circuit 150 is periodically transferred externally by way of a JTAG bus.

The FPGA is faster than an RTL simulation in executing a real application because it is shares the same cycle accuracy as that of the SOC integrated circuit. In some embodiments of the invention, the bus monitoring information is stored in the FPGA-embedded memory 151 of the monitoring circuit 150 at the FPGA design step of the SOC system and transferred externally by way of the JTAG bus. Since a user can monitor a bus state in real time while executing a practical application program, it is possible to shorten programming time and thereby reduce the development time of the SOC system. The monitoring circuit 150 may be selectively included when integrating circuits on the SOC system.

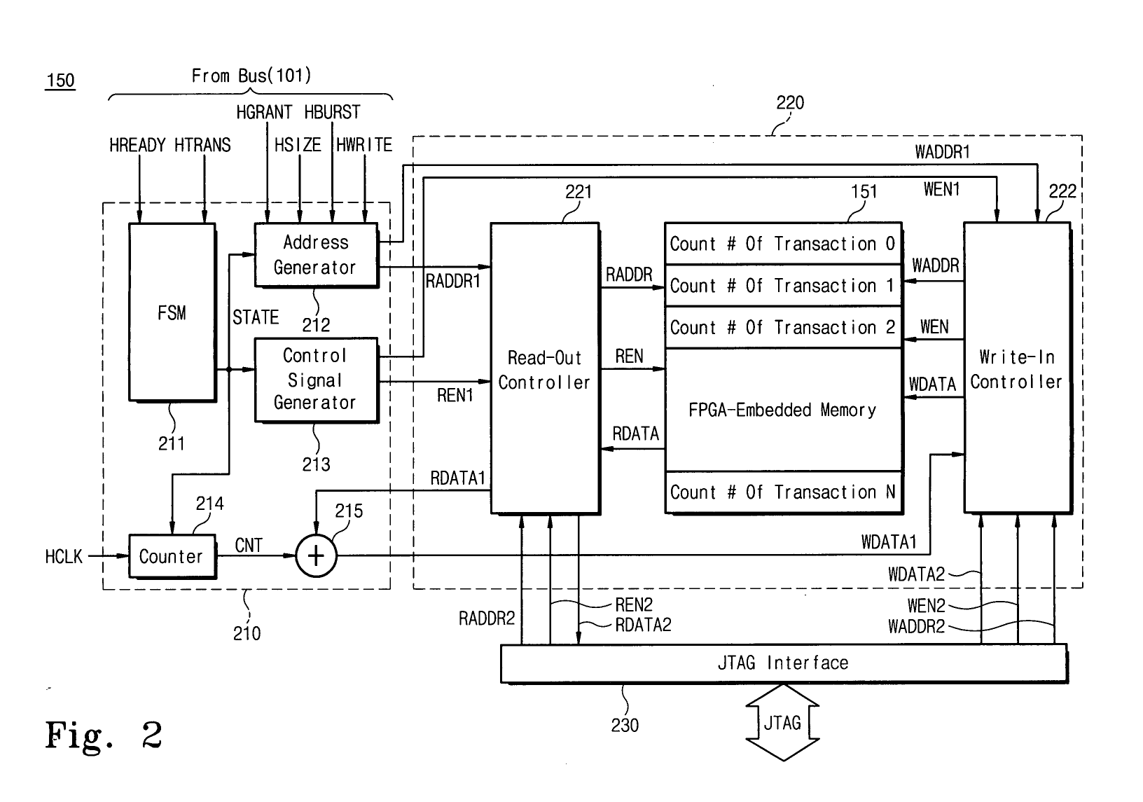

FIG. 2 is a block diagram illustrating an embodied structure of the monitoring circuit 150 shown in FIG. 1. The monitoring circuit 150 of FIG. 2 is configured to receive signals that are communicated through the bus 101 between the master units or between the master units and the arbiter, and to provide the FPGA-embedded memory 151 with information about the number of cycles used for transaction type to analyze bus occupation states of the master units. The monitoring circuit 150, which is configured for storing the bus monitoring information into the FPGA-embedded memory 151, is constructed in various configurations and is not to be restricted to the feature shown in FIG. 2.

Referring to FIG. 2, the monitoring circuit 150 includes an analyzer 210, a storage circuit 220 including an FPGA-embedded memory 151, and a JTAG interface 230.

The analyzer 210 includes a finite state machine (FSM) 211, an address generator 212, a control signal generator 213, a counter 214, and an adder 215. Signals input to the analyzer 210 from the bus 101, HCLK, HREADY, HTRANS, HGRANT, HSIZE, HBURST, and HERITE, contain the information or meanings as follows.
HCLK: system clock signal
HREADY: transfer completion
HTRANS: transfer type
HGRANT: transfer grant
HSIZE: transfer size
HBURST: burst type
   Ex) INCR4: incremental 4 burst, INCR: incremental burst
HERITE: transfer direction (write-in or read-out)

The FSM 211 receives the ready signal HREADY and the transaction signal HTRANS from the bus 101 and then outputs a bus state signal STATE. The bus state signal STATE denotes whether a signal being transferred through the bus 101 is conditioned on an address, data, or idle state.

The counter 214 operates to count the number of cycles used to execute one bus transaction, in response to the bus state signal STATE provided from the FSM 211. For instance, when the bus state signal STATE denotes a new address, the counter 214 initializes its count value CNT to ‘1’. When a signal being transferred through the bus 101 is an address or data, the counter 214 increments the count value CNT by one. The count value CNT is provided to a write-in controller 222 through the adder 215 so as to be stored into the memory 151.

The address generator 212 receives the grant signal HGRANT, the size signal HSIZE, the burst signal HBURST, and the write-in signal HWRITE from the bus 110, and outputs first read-out and write-in addresses, RADDR1 and WADDR1 to the FPGA-embedded memory 151 in response to the bus state signal STATE.

The control signal generator 213 outputs first read-out and write-in enabling signals, REN1 and WEN1, in response to the bus state signal STATE provided from the FSM 211.

The adder 215 generates a first write-in data WDATA1 by adding the count value CNT of the counter 214 to a first read-out data RDATA1 of the read-out controller 221, and supplies the first write-in data WDATA1 to the write-in controller 222.

The storage circuit 220 is comprised of the FPGA-embedded memory 151, the read-out controller 221, and the write-in controller 222. The read-out controller 221 enables read-out data RDATA to be output as the first read-out data RDATA1 from the first read-out address RADDR1 of the memory 151 in response to the first read-out enabling signal REN1 provided from the control signal generator 213 of the analyzer 210. The read-out controller 221 enables a read-out data RDATA to be output as the second read-out data RDATA2 from the second read-out address RADDR2 of the memory 151 in response to the second read-out enabling signal REN2 provided from the JTAG interface 230.

The write-in controller 222 stores the first write-in data WDATA1 of the adder 215 at the first write-in address WADDR1 of the memory 151 in response to the first write-in enabling signal WEN1 provided from the control signal generator 213 of the analyzer 210. Further, the write-in controller 222 stores the second write-in data WDATA2 of the JTAG interface 230 at the second write-in address WADDR2 of the memory 151 in response to the second write-in enabling signal WEN2 provided from the JTAG interface 230.

The JTAG interface 230 provides the read-out controller 221 with the read-out enabling signal REN2 and the read-out address RADDR2 from the external, and provides the write-in controller 222 with the write-in enabling signal WEN2, the write-in address WADDR2, and the write-in data WDATA2 from the outside.

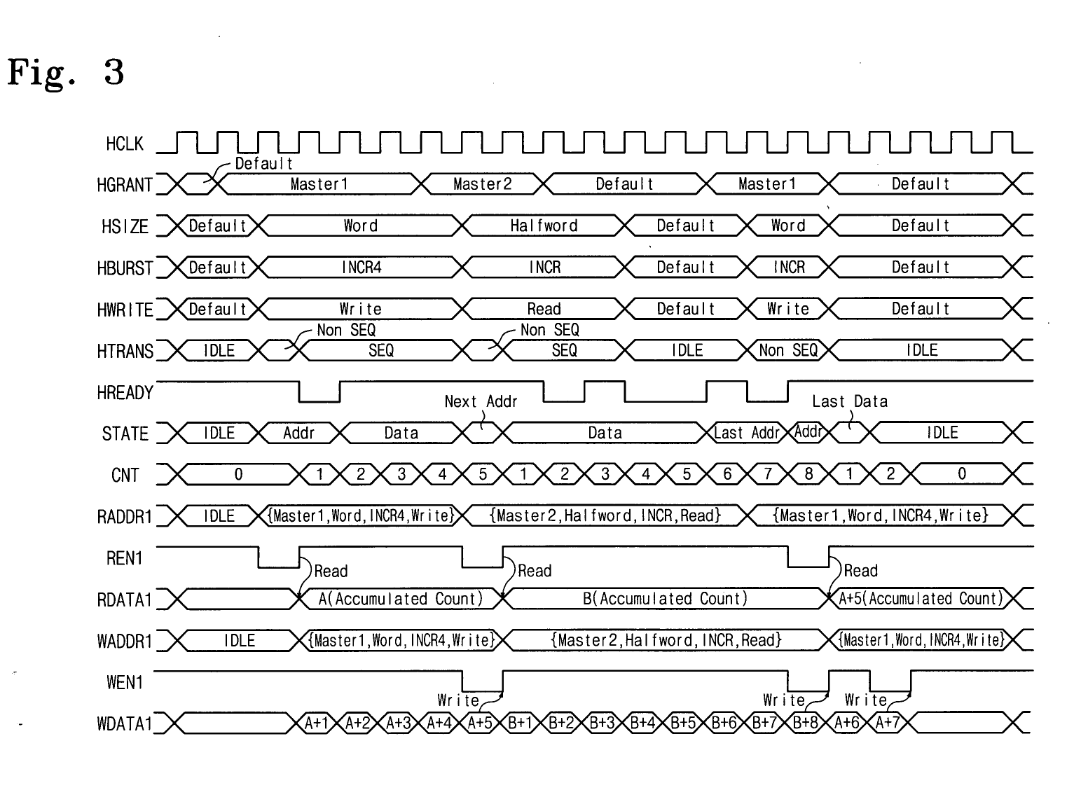

Referring to the timing diagram shown in FIG. 3, an operation of the monitoring circuit 150 shown in FIG. 2 will be described. FIG. 3 is a timing diagram showing signals operating in the monitoring circuit 150 shown in FIG. 2. For example, the following explanation is illustrative of the operation of the monitoring circuit 150 when the arbiter 120 grants the authority for bus occupation to the master unit 110 in response to a bus request by the master unit 110 shown in FIG. 1.

The master unit 110 transfers write-in command, address, and data to the memory 130 by way of the bus 101 in order to write data into the memory 130. The FSM 211 receives the signals HREADY and HTRANS and outputs the bus state signal STATE. The control signal generator 213 activates the first read-out enabling signal REN1 according to the bus state signal STATE, and the address generator 212 generates the first read-out and write-in addresses RADDR1 and WADDR1 in accordance with the bus state signal STATE and the signals HGRANT, HSIZE, HBURST, and HWRITE. In some embodiments, the first read-out address RADDR1 is identical to the first write-in address WADDR1. Furthermore, in some embodiments, the first read-out and write-in addresses, RADDR1 and WADDR1, are formatted as {master num, HSIZE, HBURST, HWRITE}.

As such, it is permissible to assign transactions each to different storage spaces in the memory 151 when the addresses RADDR1 and WADDR1 are generated in accordance with the signals HGRANT, HSIZE, HBURST, and HSIZE. Thus, it is possible to obtain information about a selected transaction by inputting a specific address corresponding thereto.

The read-out controller 221 retrieves data from the FPGA-embedded memory 151 in response to the first read-out enabling signal REN1 and the address signal RADDR1. The first read-out data RDATA1 retrieved by the read-out controller 221 is added with the count value CNT and then provided to the write-in controller 222.

The write-in controller 222 stores the first write-in data WDATA1, which is provided from the adder 215, at the corresponding position of the write-in address WADDR1 of the memory 151 when the first write-in enabling signal WEN1 from the control signal generator 213 is activated. For instance, if the first write-in enabling signal WEN1 becomes active when the data RDATA1 retrieved from the memory 151 by the read-out controller 221 is ‘A’ and the count value 215 is ‘5’, the write-in data WDATA1 becomes ‘A+5’. This means that the current transaction consumes 5 cycles and the number of cycles (clock, program, or system) accumulated by the same transactions is ‘A+5’.

As such, the monitoring circuit 150 stores information about the transaction time, such as the number of cycles used or consumed for the transaction, into the FPGA-embedded memory 151 when the transaction is generated between two units through the bus 101. Thereafter, if the same transaction occurs, the cycle information is read out from the FPGA-embedded memory 151 and added to the number of currently used or consumed cycles. The added result is re-stored in the FPGA-embedded memory 151. While this embodiment illustrates that that information about the cycles consumed for the transaction is stored in the FPGA-embedded memory 151, it is also possible to store additional information, such as information about the types or number of units of data transferred or the associated patterns of such transferred data into the memory 151.

The transaction information stored in the FPGA-embedded memory 151 is transferred externally by way of the JTAG interface 230. More specifically, according to some embodiments of the present invention, the read-out controller 221 outputs the read-out data RDATA2 to the outside through the JTAG interface 230 in response to the second read-out address RADDR2 and the second read-out enabling signal REN2, which are provided from outside the device also through the JTAG interface 230.

Additionally, it may be permissible to write data in the FPGA-embedded memory 151 through the JTAG interface 230 from outside the device. During this time, the second write-in data WDATA2, the second write-in enabling signal WEN2, and the second write-in address WADDR2 can be provided to the write-in controller 222 through the JTAG interface 230. The mode of writing data in the FPGA-embedded memory 151 through the JTAG interface 230 from outside the device may be active when clearing the FPGA-embedded memory 151 or storing an initial value in the memory 151.

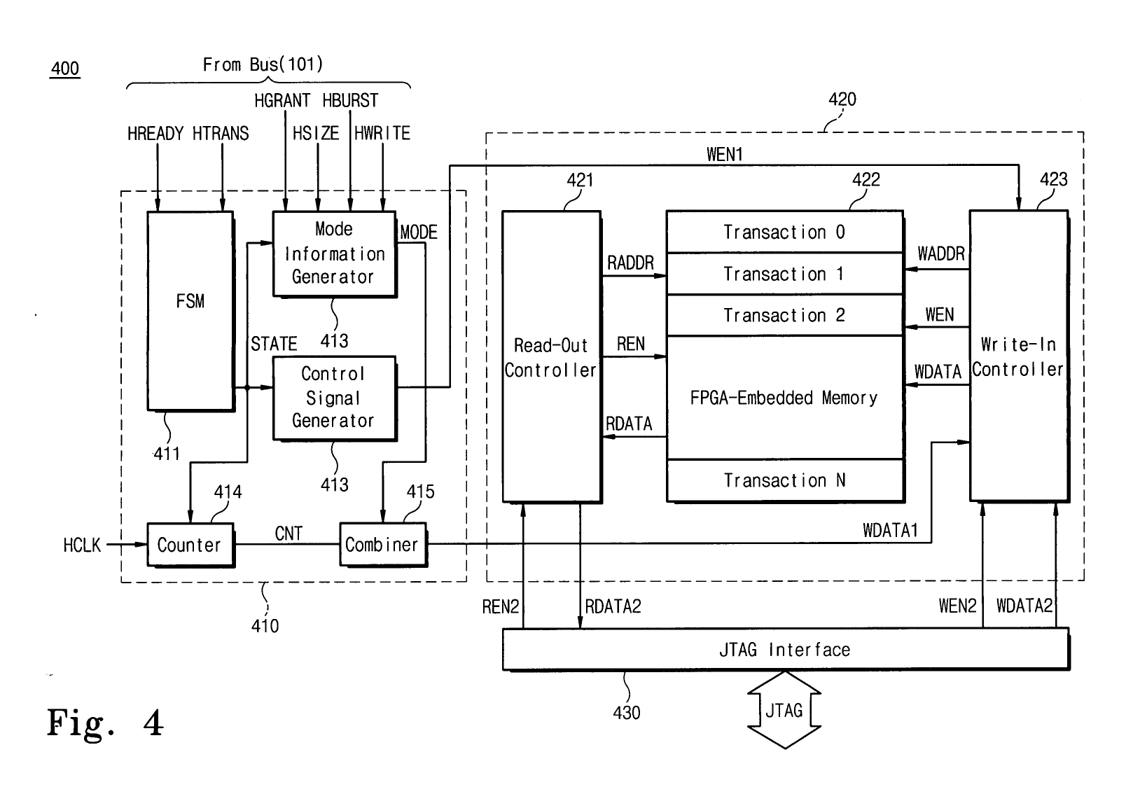

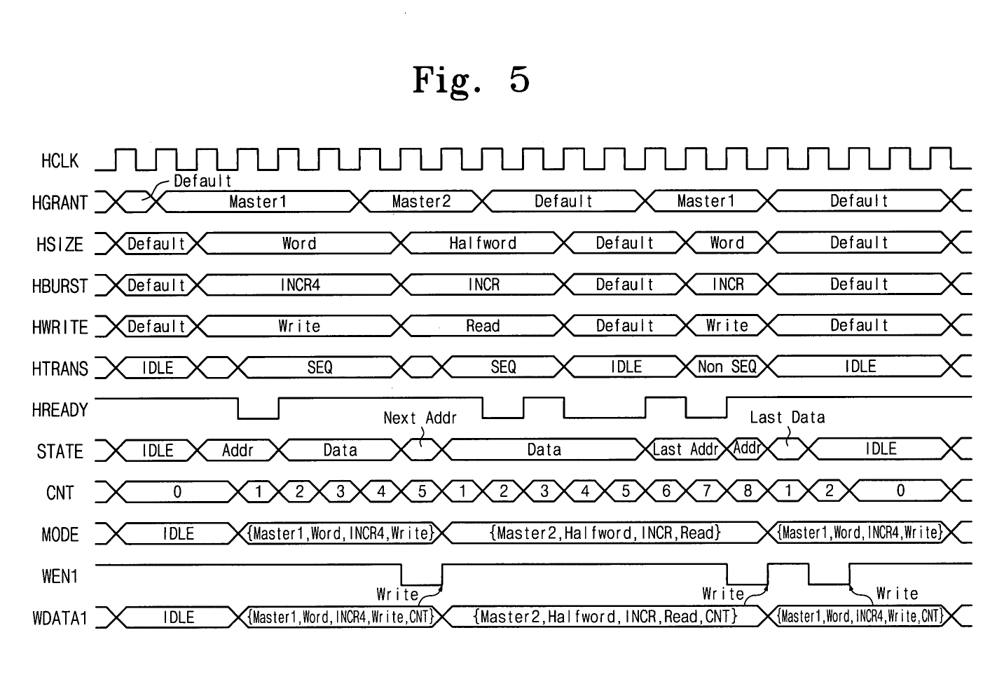

FIG. 4 is a block diagram illustrating a monitoring circuit in accordance with some embodiments of the invention, and FIG. 5 is a timing diagram showing signals operating according to some embodiments of the monitoring circuit shown in FIG. 4.

Referring to FIG. 4, the monitoring circuit 400 includes an analyzer 410, a storage circuit 420, and a JTAG interface 430. The analyzer 410 includes a FSM 411, a mode information generator 412, a control signal generator 413, a counter 414, and a combiner 415. The FSM 411 receives the ready signal HREADY and the transaction signal HTRANS from the bus 101 and then outputs the bus state signal STATE. The bus state signal STATE denotes whether a signal being transferred through the bus 101 is conditioned on an address, data, or idle state.

The counter 414 counts the number of cycles used for executing one bus transaction in response to the bus state signal STATE provided from the FSM 411. For instance, when the bus state signal STATE denotes a new address, the counter 414 initializes its count value CNT on ‘1’. When a signal being communicated through the bus 101 is an address or data, the counter 414 increments the count value CNT by one. The count value CNT is provided to the combiner 415.

The mode information generator 212 receives the grant signal HGRANT, the size signal HSIZE, the burst signal HBURST, and the write-in signal HWRITE from the system bus 101 and then outputs a mode information signal MODE, which is encoded, in response to the bus state signal STATE provided from the FSM 411. In the embodiment shown by FIG. 5, the mode information signal MODE may be formed in the configuration of {HGRANT, HSIZE, HBURST, HWRITE}. The control signal generator 413 outputs the first write-in enabling signals WEN1 in response to the bus state signal STATE provided from the FSM 411.

The combiner 415 concatenates the mode information signal MODE of the mode information generator 412 with the count value CNT of the counter 414, and then outputs the merged result as the first write-in data WDATA1. While this embodiment illustrates the feature of concatenating (or combining) the mode information signal MODE with the bits of the count value CNT, other methods may be employed for combining the mode information signal MODE and the count value CNT with each other. The first write-in data WDATA1 is the transaction information to be provided to the write-in controller 423. In the embodied feature shown in FIG, 5, the fist write-in data WDATA1, i.e., the transaction information, is formatted as {HFRANT, HSIZE, HBURST, HWRITE, CNT}.

The storage circuit 420 includes the read-out controller 421, the FPGA-embedded memory 422, and the write-in controller 423. The write-in controller 423 stores the first write-in data WDATA1 of the combiner 415 into the first write-in address WADDR1 of the memory 422 in response to the fist write-in enabling signal WEN1 provided from the control signal generator 413 of the analyzer 410. The write-in controller 423 generates the write-in address WADD, activates the write-in enabling signal WEN, and outputs the first write-in data WDATA1 of the combiner 415 as the write-in data WDATA, in response to the second write-in enabling signal WEN2 provided from the JTAG interface 430. The write-in address WADDR increases in sequence whenever the write-in enabling signal WEN becomes active.

The read-out controller 421 retrieves the transaction information from the memory 422 and outputs the read-out data RDATA2 externally through the JTAG interface 430 in response to the read-out enabling signal REN2 that is provided from the JTAG interface 430. The read-out address RADDR increases in sequence whenever the read-out enabling signal REN becomes active. In this embodiment, the read-out address RADDR is confined within the range of storing the transaction information in the memory 422.

The monitoring circuit 400 as illustrated in FIG. 4 may use the FPGA-embedded memory 422 as a first-in first-output (FIFO) memory so as to store the transaction information therein.

Some embodiments according to the present invention provide a means for monitoring a bus state in real time while executing application programs by storing transaction information obtained from a bus monitoring operation into the FPGA-embedded memory. As a result, it is possible to reduce programming time and shorten the development period for an SOC system.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An integrated circuit device comprising:
a bus;
at least two master units coupled to the bus; and
a monitoring circuit configured to monitor transactions of the master units through the bus, wherein the monitoring circuit comprises FPGA-embedded memory configured to store transaction information.

2. The integrated circuit device according to claim 1, wherein the monitoring circuit comprises a controller to write the transaction information in the FPGA-embedded memory and/or read the transaction information from the FPGA-embedded memory.

3. The integrated circuit device according to claim 1, wherein the monitoring circuit comprises an interface configured to output the transaction information from the FPGA-embedded memory to the outside.

4. The integrated circuit device according to claim 3, wherein the interface is a joint test access group (JTAG) interface.

5. The integrated circuit device according to claim 1, wherein the device comprises an arbiter configured to arbitrate the transactions of the master units in occupying the bus.

6. The integrated circuit device according to claim 1, wherein the monitoring circuit comprises:
an analyzer configured to receive a signal communicated between the master units through the bus and generate an address signal, at least one control signal, and the transaction information in accordance with the communicated signal; and
a storage circuit configured to store the transaction information into the FPGA-embedded memory and/or read the transaction information from the FPGA-embedded memory in response to the address and the at least one control signal.

7. The integrated circuit device according to claim 6, wherein the transaction information includes information about a time used for the transaction.

8. The integrated circuit device according to claim 6, wherein the transaction information includes information about a number of cycles used for the transaction.

9. The integrated circuit device according to claim 6, wherein the analyzer of the monitoring circuit is configured to generate an address signal correspondent with the transaction.

10. The integrated circuit device according to claim 6, wherein the storage circuit of the monitoring circuit is configured to read out information about an accumulated transaction time from the FPGA-embedded memory in response to the address and control signals.

11. The integrated circuit device according to claim 10, wherein the analyzer of the monitoring circuit comprises an adder configured to add a transaction time to the accumulated transaction time,
wherein the storage circuit comprises means configured to store information concerning transaction time into the FPGA-embedded memory from the adder and/or read out information from the FPGA-embedded memory for transmission to the adder in response to the address and at least one control signal.

12. The integrated circuit device according to claim 1, wherein the monitoring circuit comprises:
an analyzer configured to receive a signal communicated between the master units through the bus and generate the transaction information and at least one control signal in accordance with the communicated signal; and
a storage circuit configured to store the transaction information into the FPGA-embedded memory and/or read the transaction information from the FPGA-embedded memory in response to the at least one control signal.

13. The integrated circuit device according to claim 12, wherein the storage circuit is configured to generate addresses of FPGA-embedded memory in sequence and store the transaction information at the addresses of FPGA-embedded memory.

14. The integrated circuit device according to claim 12, wherein the transaction information includes information about an operation mode and a transaction processing time in accordance with the signal communicated between the master units through the bus.

15. A method for monitoring a bus, comprising:
receiving signals by way of a bus;
generating transaction information in correspondence with the signals; and
storing the transaction information into an FPGA-embedded memory.

16. The method according to claim 15, wherein the transaction information includes a time for processing the transaction.

17. The method according to claim 15, wherein the transaction information includes a number of cycles for processing the transaction.

18. The method according to claim 15, wherein the transaction information includes information about a transaction mode.

19. The method according to claim 15, comprising regulating transactions in occupying the bus.

20. A method for monitoring a bus, comprising:
generating an address of the FPGA-embedded memory in response to signals transferred through a bus;
obtaining transaction information in response to the signals transferred through the bus;
reading out accumulated transaction information from the FPGA-embedded memory address;
adding the transaction information to the accumulated transaction information; and
storing the accumulated transaction information into the address of the FPGA-embedded memory.

21. The method according to claim 20, wherein the transaction information includes information about a time used for the transaction.

22. The method according to claim 20, wherein the transaction information includes information about a number of cycles used for the transaction.

23. The method according to claim 20, comprising regulating transactions in occupying the bus.

24. A method for monitoring a bus, comprising:
generating transaction mode information in response to signals transferred through a bus;
obtaining information about a transaction time used for a transaction in response to the signals transferred through the bus;
generating an address of the FPGA-embedded memory; and
storing the transaction time information and the transaction mode information into the address of the FPGA-embedded memory.

25. The method according to claim 24, wherein the transaction time information includes a number of cycles used for the transaction.

26. The method according to claim 24, comprising:
reading out accumulated transaction time information from the FPGA-embedded memory address;
adding the transaction time information to the accumulated time transaction information; and
storing the accumulated transaction time information into the address of the FPGA-embedded memory.

27. The method according to claim 26, wherein the transaction time information includes a number of cycles used for the transaction.

28. The method according to claim 24, further comprising:
reading out accumulated transaction mode information from the FPGA-embedded memory address;
combining the transaction mode information with the accumulated transaction mode information; and
storing the accumulated transaction mode information into the address of the FPGA-embedded memory.

29. A method of monitoring a bus comprising:
monitoring transactions of master units over the bus including storing transaction information in a programmable device-embedded memory.

30. A computer program product for monitoring transactions on a bus comprising a computer readable medium having computer readable program code embodied therein, the computer readable program product comprising:
computer readable program code configured to carry out the method according to claim 29.
